(19) United States
(12) Patent Application Publication
(10) Pub. No.: US 2009/0323673 A1
(43) Pub. Date: Dec. 31, 2009

(54) Portable Soft Phone

(75) Inventors: Avi Gabbay, Ramat-Gan (IL); Zvi Knobler, Tel-aviv (IL)

Correspondence Address: Husch Blackwell Sanders, LLP;Husch Blackwell Sanders LLP Welsh & Katz, 120 S RIVERSIDE PLAZA, 22ND FLOOR, CHICAGO, IL, 60606, US

(73) Assignee: OUT-SMART LTD, LOD (IL)

(21) Appl. No.: 12/223,608

(22) PCT Filed: Feb. 13, 2007
(86) PCT No.: PCT/IL07/00196

§ 371 Date: Dec. 15, 2008

Related U.S. Application Data
(60) Provisional application No. 60/773,050, filed on Feb. 13, 2006.

(51) Int. Cl. H04L 12/66; H04W 4/00; H04B 1/38

(52) U.S. Cl. 370/352; 370/328; 455/558

(57) ABSTRACT

A communication device (22) includes a computer interface (84), for coupling to a computer (26), which is connected to communicate over a packet-switched network (28). A secure memory interface (82) in the device is coupled to a secure memory (64) containing subscriber identification data belonging to a subscriber. A program memory (88) in the device contains an executable application program, which is configured to be read by the computer via the computer interface and upon execution by the computer, causes the computer to communicate via the packet-switched network with a telephony gateway (34) so as to register the subscriber with the gateway using the subscriber identification data and to communicate, under control of a user of the computer, via the gateway with a telephone network (38).

### CROSS-REFERENCE TO RELATED APPLICATION

This application claims the benefit of U.S. Provisional Patent Application 60/773,050, filed Feb. 13, 2006, which is incorporated herein by reference.

### FIELD OF THE INVENTION

The present invention relates generally to communication networks, and specifically to convergence of packet telephony with cellular and other circuit-switched telephone networks.

### BACKGROUND OF THE INVENTION

Packet telephony systems, particularly using Voice over Internet Protocol (VoIP), permit packet telephone calls to be placed between IP terminals, which are identified by IP addresses rather than telephone numbers. The Session Initiation Protocol (SIP) is most commonly used for call signaling, while the media (audio data) are carried between the terminals by Real Time Protocol (RTP) packets.

Calls between IP terminals and telephones in circuit-switched networks (such as cellular and wireline telephone networks) may be placed via suitable VoIP gateways. The VoIP gateway typically converts SIP packets to Signaling System 7 (SS7) messages and RTP packets to pulse-code modulated (PCM) audio signals, and vice versa. For example, U.S Patent Application Publication US 2003/0076815 A1, whose disclosure is incorporated herein by reference, describes a VoIP architecture in which a signaling gateway provides transparent inter-operation between the VoIP network and the public switched telephone network (PSTN) by translating messages between the networks. Other methods for connecting VoIP and SS7 networks are described in U.S. Pat. Nos. 6,075,783, 6,324,183 and 6,683,881, whose disclosures are also incorporated herein by reference.

PCT Patent Publication WO 2005/084128, whose disclosure is incorporated herein by reference, describes a convergence gateway for coupling a packet telephone network to a circuit-switched network. The gateway emulates the function of a switch, such as a mobile switching center (MSC), in the circuit-switched network, so that the connection between the networks is transparent to the existing infrastructure of the circuit-switched network. Telephones on the packet network may thus be assigned conventional telephone numbers in the circuit-switched network, with the convergence gateway serving as the visitor location register (VLR) for these numbers. The MSC/VLR function of the convergence gateway maps the telephone numbers to the appropriate packet network addresses and converts the call signaling and media from SS7/PCM to the appropriate packet network protocols, such as SIP/RTP. The gateway performs the reverse processes when subscribers in the packet network place calls to telephone numbers in the circuit-switched network. This arrangement also permits packet network subscribers to use (and be billed for) the services of the circuit-switched network.

Telephones used in cellular networks typically contain a subscriber identity module (SIM)—a removable smart card that securely stores information identifying the subscriber. The SIM card allows users to change phones easily by removing the SIM card and inserting it into another mobile phone. Although the SIM card originated as part of the Global System for Mobile (GSM) telephone standards, equivalent identity modules are now used in other types of cellular networks, as well. The term “SIM” is used generically in the context of the present patent application and in the claims to refer to all types of secure identity modules that are used to identify subscribers in mobile telephone networks.

SIM cards may also be plugged into a computer for applications such as SIM-based subscriber identification in public wireless local area network (WLAN) access. For this purpose, for example, Haverinen and Salowey describe an extensible authentication protocol (EAP) for authentication and session key distribution using a SIM in Request for Comments (RFC) 4186 of the Internet Engineering Task Force (IETF), entitled “Extensible Authentication Protocol Method for Global System for Mobile Communications (GSM) Subscriber Identity Modules (EAP-SIM)” (January, 2006), which is incorporated herein by reference. (This document is available at tools.ietf.org/html/rfc4186.)

Products implementing EAP-SIM are commercially available. For example, Gemalto (Amsterdam, Netherlands) offers a SIM plug-in with a Universal Serial Bus (USB) interface that plugs into the USB port of a personal computer. (Information about this product is available at www.axalto.com/wireless/wifi.asp.) The device supports standard GSM authentication algorithms, with security calculations performed on the card.

### SUMMARY OF THE INVENTION

Embodiments of the present invention that are described hereinbelow provide devices and methods that use SIM-based authentication to make telephone network services available to subscribers on a packet-switched network. In some of these embodiments, a SIM-based device, which plugs into a computer on a packet network, contains embedded software that automatically registers with a telephony gateway when the device is plugged in. After authenticating the subscriber identity information contained in the device, the gateway enables the subscriber to access services offered by a telephone network, including placing and receiving telephone calls (using a telephone number identified by the SIM), as well as other value-added services. In other embodiments, similar functionality is provided using a SIM-based analog telephone adapter.

There is therefore provided, in accordance with an embodiment of the present invention, a communication device, including:

a computer interface, for coupling to a computer, which is connected to communicate over a packet-switched network;

a secure memory interface, for coupling to a secure memory containing subscriber identification data belonging to a subscriber; and

a program memory, containing an executable application program, which is configured to be read by the computer via the computer interface and upon execution by the computer, causes the computer to communicate via the packet-switched network with a telephony gateway so as to register the subscriber with the gateway using the subscriber identification data and to communicate, under control of a user of the computer, via the gateway with a telephone network.

In some embodiments, the computer interface includes a Universal Serial Bus (USB) connector, for coupling to a USB port of the computer, and the secure memory includes a subscriber identification module (SIM) card. Typically, the secure memory interface includes a receptacle for receiving and coupling to the SIM card. In one embodiment, the subscriber identification data includes an international mobile subscriber identity (IMSI), and the SIM card further contains a key for secure authentication of the subscriber. Typically, the application program causes the computer to convey to the telephony gateway authentication information responsive to the key, for use by the telephony gateway in authenticating the subscriber with an authentication server belonging to the telephone network. The application program may cause the computer to convey the authentication information using a Session Initiation Protocol (SIP) message.

In a disclosed embodiment, the telephone network includes a cellular telephone network.

Typically, the executable application program includes a soft phone program, which causes the computer to place a call to the telephone network. In a disclosed embodiment, the call includes a voice telephone call, and the apparatus includes an audio interface in the device, for coupling to audio input and output devices, to receive and deliver voice input and output during the voice telephone call.

In some embodiments, the device includes a data memory, wherein the application program causes the computer to read user data from and write user data to the data memory under the control of the user. In one embodiment, the user data includes contact information that is maintained in an address book of the user. Additionally or alternatively, the user data includes content that is received by the computer via the telephony gateway and is written by the computer to the data memory. The content may include audio content, and the device may include an audio interface, for coupling to an audio output device, and a controller, which is configured to play the audio content for output via the audio interface after the device has been disconnected from the computer.

In a disclosed embodiment, the computer interface and application program are configured so that the application program runs automatically on the computer when the device is coupled to the computer, without installation of the program in a memory of the computer.

There is also provided, in accordance with an embodiment of the present invention, a communication device, including:

a telephone interface, for coupling to an analog telephone;

a network interface, for coupling to a packet-switched network;

a secure memory interface, for coupling to a secure memory containing subscriber identification data belonging to a subscriber; and

a controller, which is configured to communicate via the packet-switched network with a telephony gateway so as to register the subscriber with the gateway using the subscriber identification data and to place a call, under control of a user of the analog telephone, via the gateway to a telephone network.

There is additionally provided, in accordance with an embodiment of the present invention, a method for communication, including:

coupling a user-authentication device to a computer, the device including a secure memory, containing subscriber identification data belonging to a subscriber, and a program memory, containing an executable application program;

executing the application program on the computer;

under control of the soft phone program, establishing communication over a packet-switched network between the computer and a telephony gateway so as to register the subscriber with the gateway using the subscriber identification data; and

after registering the subscriber, initiating the communication, under control of a user of the computer, from the computer via the gateway to a telephone network.

There is moreover provided, in accordance with an embodiment of the present invention, a method for communication, including:

coupling an analog telephone adapter to an analog telephone, the adapter including a secure memory, containing subscriber identification data belonging to a subscriber;

establishing communication over a packet-switched network between the adapter and a telephony gateway so as to register the subscriber with the gateway using the subscriber identification data; and

after registering the subscriber, placing a call, under control of a user of the analog telephone, from the computer via the gateway to a telephone network.

The present invention will be more fully understood from the following detailed description of the embodiments thereof, taken together with the drawings in which:

### BRIEF DESCRIPTION OF THE DRAWINGS

FIG. 1 is a schematic, pictorial illustration of a communication network system, in accordance with an embodiment of the present invention;

FIG. 2 is a schematic, pictorial illustration of a plug-in device for packet telephony, in accordance with an embodiment of the present invention;

FIG. 3 is a block diagram that schematically shows functional components of a device for packet telephony, in accordance with an embodiment of the present invention;

FIG. 4 is a message flow diagram that schematically illustrates a method for registering a subscriber on a network, in accordance with an embodiment of the present invention;

FIG. 5 is a schematic, pictorial illustration of an analog telephone adapter, in accordance with an alternative embodiment of the present invention; and

FIG. 6 is a block diagram that schematically shows functional components of an analog telephone adapter, in accordance with an alternative embodiment of the present invention.

### DETAILED DESCRIPTION OF EMBODIMENTS

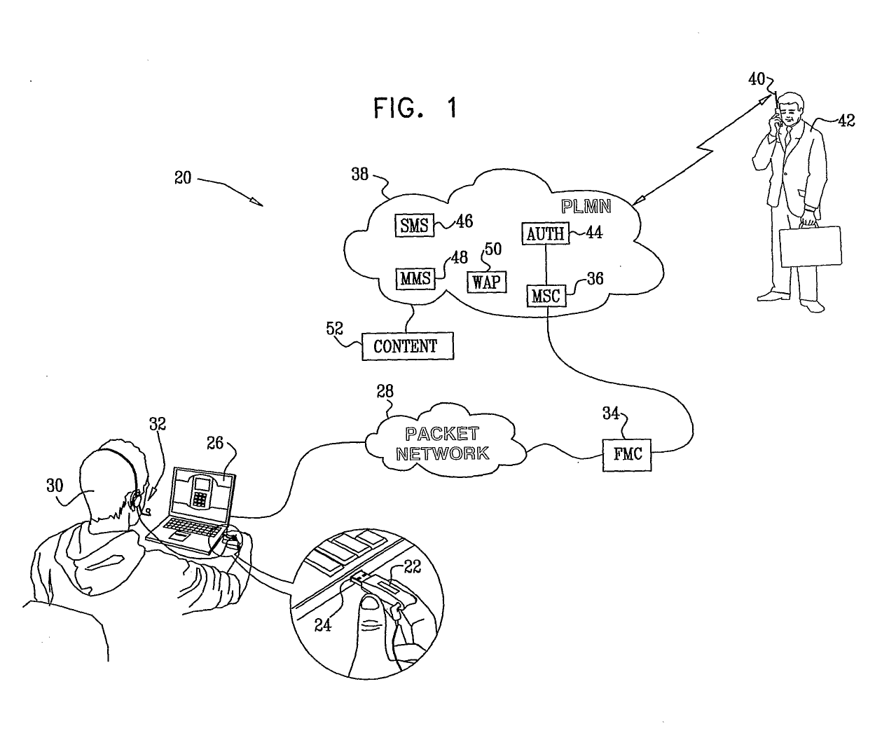

FIG. 1 is a schematic, pictorial illustration of a communication network system 20, in accordance with an embodiment of the present invention. To access system 20, a user 30 connects a subscriber identification device 22 to a port 24 of a computer 26. In the description of device 22 hereinbelow, it is assumed that the device contains a secure memory in the form of a SIM card for purposes of subscriber identification, and that port 24 is a USB interface port of computer 26. The SIM card is programmed, as is known in the art, with subscriber identification data, including a telephone number (typically the International Mobile Subscriber Identity—IMSI), and a security key. Alternatively, device 22 may be loaded with identification data in any other form and in any other type of secure memory that is suitable for the purposes described hereinbelow. Further additionally or alternatively, although the present embodiment is described with reference to a USB interface, device 22 may be configured to mate with any other suitable interface of the computer, which may comprise a wired input/output (I/O) port or a wireless “virtual port,” such as an infrared or Bluetooth™ I/O channel.

Device 22 enables user 30 to place calls and use other services on a telephone network 38 via a telephony gateway 34. For this purpose, the device is loaded with an executable application program, which typically comprises a soft phone program, i.e., a program that enables the user to place and receive voice calls via a packet-switched communication network 28, such as the Internet, to which computer 26 and gateway 34 are connected. Additionally or alternatively, the application program may enable the user to place and receive messages of other sorts, such as short message service (SMS) and multimedia message service (MMS) messages, or to access other services of network 28. Device 22 may also comprise an audio interface, for coupling to audio input and output devices 32 to be used in such voice calls. Alternatively, the soft phone program may make use of audio input and output devices and corresponding drivers that are already installed in computer 26. The configuration shown in the figures, however, in which the soft phone program uses an audio interface that is built into device 22, is advantageous in that it ensures that there will be no problems of compatibility or competition for the audio resources of the computer in soft phone operation.

When device 22 is plugged into port 24, computer 26 reads and executes the soft phone program. Typically, device 22 is configured to emulate a CD-ROM drive, so that the soft phone program begins to execute automatically when the computer is turned on or when the device is plugged in, without requiring installation of the program on the computer. Execution of the program causes the computer to communicate via packet-switched network 28 with gateway 34, which provides access to telephone network 38. The computer may be connected to network 28 via either a wired or a wireless connection. The soft phone program uses a predetermined protocol, such as SIP, to register the subscriber with the gateway using the subscriber identification data stored in device 22. Once registration has been completed, user 30 is able to place and receive calls on network 38 via the gateway, using the IMSI or other telephone number that is associated with the identification data in device 22, as though the user was actually connected directly to network 38.

The configuration of device 22 that is described above is advantageous in that it enables user 30 to place and receive VoIP calls using the same telephone number from substantially any computer in any location with an Internet connection. There is no need for the user to install or configure software on the computer. Rather, all the user generally has to do is to plug device 22 into the computer, and unplug the device when he or she is done. Because device 22 requires no software installation, it typically leaves no trace in the memory of the computer that might subsequently compromise the operation of the computer or enable a hacker to steal the user's identification information. Thus, device 22 enables users to place and receive VoIP calls with mobility, convenience and security that approach those enjoyed by cellular telephone users.

These advantages are due in part to the cooperation of device 22 with gateway 34, which provides access to authentication facilities and other services of telephone network 38. A suitable gateway of this sort is described in the above-mentioned PCT Patent Publication WO 2005/084128, where the gateway is referred to as a “fixed-mobile convergence” (FMC) gateway, since it interfaces between a fixed IP network and a public land mobile network (PLMN), i.e., a cellular telephone network. Alternatively, device 22 may operate in conjunction with gateways of other types, which may interface with various sorts of telephone networks, both fixed and mobile. Such telephone networks, such as the PLMN and public switched telephone network (PSTN) are generally referred to as circuit-switched networks, but the principles of the present invention are also applicable to interworking of packet network 28 with advanced telephone networks that use packet switching models.

With respect to telephone network 38, FMC gateway 34 emulates the operation of a mobile switching center (MSC), which communicates with switches in network 38, such as a MSC 36. Specifically, gateway 34 emulates the function of the visitor location register (VLR) (which is typically, although not necessarily, associated with the MSC). The telephone number that is associated with device 22, as well as numbers that are assigned to other user terminals on packet network 28, is recorded in the emulated VLR. This emulation function is described in greater detail in the above-mentioned PCT publication. It permits a user 42 of a telephone 40 in telephone network 38 to place calls transparently to user 30 on packet network 28 simply by dialing the assigned number. User 30 may similarly place calls through gateway 34 to the telephones in telephone network 38.

FMC gateway 34 is thus responsible, with respect to computer 26, for all the essential functions of a conventional MSC in telephone network 38, such as registration, authentication and call routing. In the authentication process, which is described in detail hereinbelow, gateway 34 uses the secure key that is stored in device 22 to register the subscriber with an authentication server 44 in network 38. This registration enables the operator of network 38 to charge the subscriber's account for telephone services, in the same manner as cellular telephone subscribers are charged. Furthermore, because FMC gateway 34 appears to network 38 to be simply another MSC, user 30 on packet network 28 may also place and receive calls through the gateway to and from other networks that are connected to network 38, such as the PSTN and other cellular networks. The connection to these other networks may be via mobile network 26 or, alternatively, by direct connection between the FMC gateway and the other networks.

In addition, the operator of network 38 may offer user 30 other services of network 38 (and charge for provision of these services) for access via gateway 34. For example, the user may access a short message service (SMS) center 46, a multimedia message service (MMS) center 48, and/or a wireless access protocol (WAP) gateway 50. The user may also access content providers 52 via gateway 50 (or via other suitable servers in network 38), typically for a fee, in order to download content, such as music recording, images, or programs. The content may be stored in the memory of device 22, as described hereinbelow, or on computer 26.

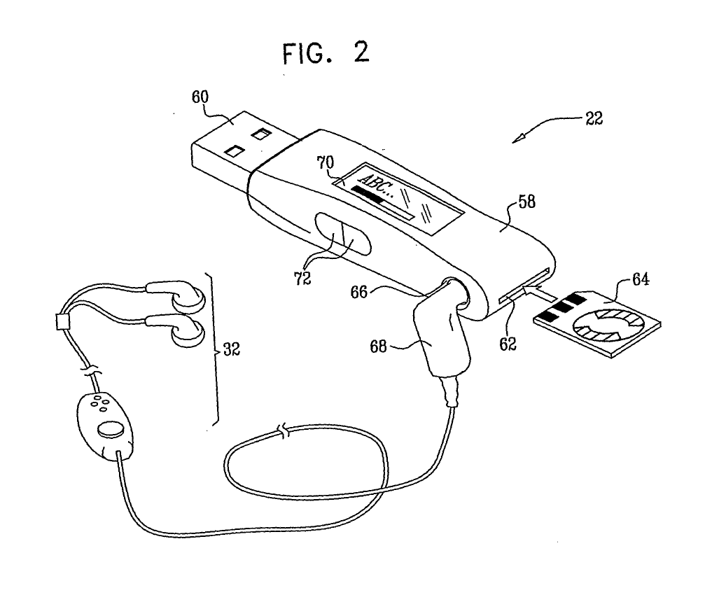

FIG. 2 is a schematic, pictorial illustration showing details of subscriber identification device 22, in accordance with an embodiment of the present invention. Device 22 comprises a housing 58, with a connector 60 for connecting to port 24 of computer 26. (As noted earlier, device 22 may alternatively comprise any other suitable type of interface, either wired or wireless, for connecting to the computer.) The device contains a receptacle 62, such as a suitable slot with connection terminals, for receiving a SIM card 64. Alternatively, the SIM secure memory may be permanently installed in device 22, either on a non-removable SIM card or on a secure memory chip. Optionally, housing 58 also has an audio socket 66, for connecting to a plug 68 of audio I/O devices 32.

As noted above, when connector 60 of device 22 is plugged into port 24 of computer 26, the computer runs the soft phone program that is stored in the device. User 30 may then access the functions of device 22 using the keyboard and/or mouse of computer 26 to interact with the on-screen interface of the soft phone program. Thus, device 22 may be furnished without any user interface elements on the device itself.

Alternatively, however, device 22 may comprise a display 70 and user controls 72 on the exterior of housing 58. These user interface elements may be used, for example, to permit the user to adjust audio volume, as well as to access content that that is stored in the memory of device 22 even while the device is not plugged into a computer. (As noted above, such content may have been downloaded from content providers 52 while the device was connected to computer 26.) In this configuration, device 22 may serve as a portable audio player, in addition to its primary function in telephone network access.

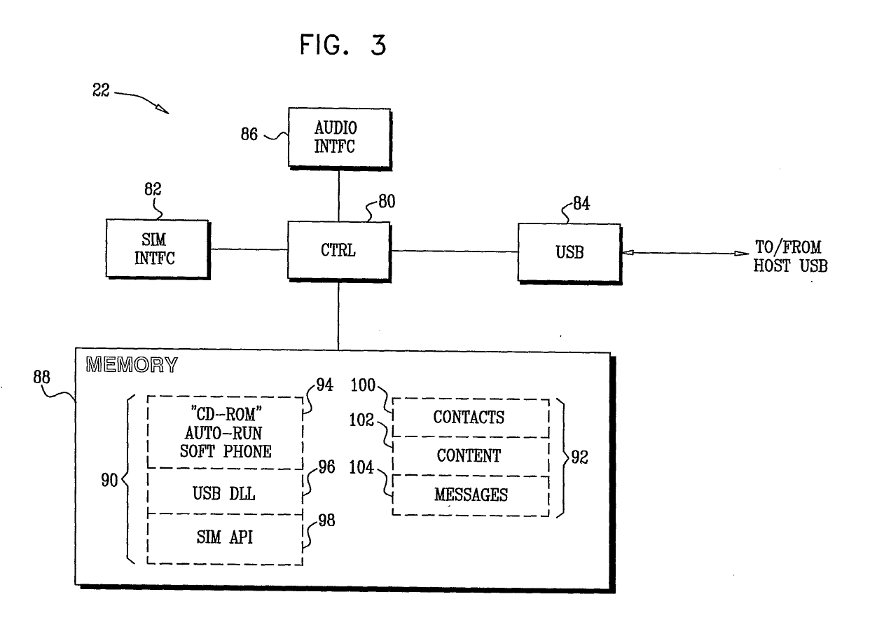

FIG. 3 is a block diagram that schematically shows functional elements of device 22, in accordance with an embodiment of the present invention. The functions of the device are coordinated by a microcontroller 80, which communicates with SIM card 64 via a suitable SIM interface 82 and with computer 26 via a USB interface 84. An optional audio interface 86 decodes digital audio signals to generate analog audio output to audio I/O devices 32 and receives, digitizes and encodes audio input from devices 32.

Although the microcontroller and interfaces are shown in the figure, for the sake of conceptual clarity, as separate components, at least some of these functions may in practice be combined in a single integrated circuit chip or a set of two or more such chips with suitable interfaces and firmware. Alternatively, some of these functions may be divided among different components, such as separate analog and digital components. These various alternative implementations will be apparent to those skilled in the art and are considered to be within the scope of the present invention. Certain other components that are not essential to an understanding of the operation of device 22 have been omitted from the figure for the sake of simplicity.

Device 22 comprises a non-volatile memory 88, such as Flash memory and/or ROM. The memory is divided into two partitions: a program area 90 and a user area 92. The program area contains program code used to drive operation of device 22 and to load and run the soft phone program on computer 26 when the device is plugged into the computer. The program area is not accessible to the user, although it may be accessed by the supplier of device 22 for purposes of program updates. (For example, when communications are established between computer 26 and gateway 34, the gateway may download software code to area 90 of memory 88 by transmitting a certain instruction sequence to controller 80.)

Program area 90 of memory 88 contains a soft phone program 94 and a USB dynamic link library (DLL) 96. These software elements are typically configured to emulate a CD-ROM drive, so that they load and run on computer 26 automatically when device 22 is plugged into port 24. The soft phone program is similar to programs that are currently available for VoIP communication using a personal computer, with the exception of the software interfaces to gateway 34 and to device 22. Assuming device 22 is equipped with audio interface 86, the soft phone program relates to USB port 24 as its audio I/O device. The soft phone program also permits the user to interact with user area 92 of memory 88, as described hereinbelow.

A SIM application program interface (API) 98 in program area 90 of memory 88 is used by the soft phone program in communicating with SIM card 64 via SIM interface 82. API 98 typically includes the following functions:
int GetInfo (char *IMSI, char *MSISDN, char *CardNo)

This function is used for retrieving identification information from the SIM card. It is typically called at startup of device 22 in order to verify that the SIM card is inserted and to get identification information for later authentication. These parameters generally include the User Name (in the form of a mobile station international subscriber identity number—MSISDN) and Authorized User Name (IMSI), as well as a pointer to a buffer to be used for retrieving the SIM key (CardNo).
int GetAuthInfo (char *challenge, char *result)

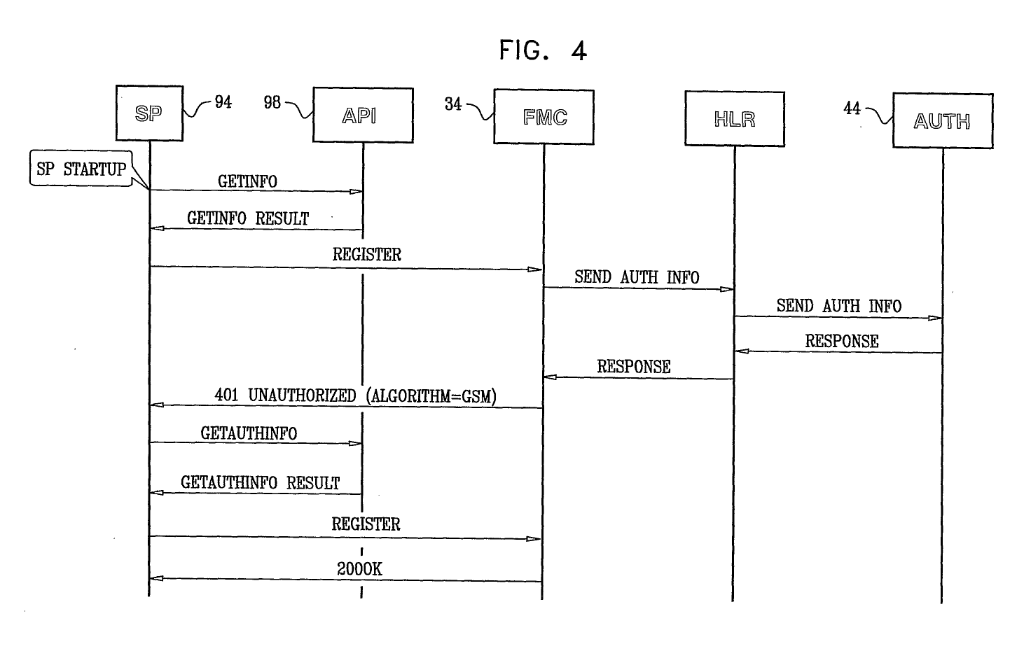

This function is used to activate the authentication algorithm using the SIM card. It is called when computer 26 receives an authentication request (such as a SIP 401 or 407 authentication message) with the ALGORITHM tag set to GSM. The input Challenge parameter contains the challenge sent from authorization server 44, while Result points to a buffer that is to be used for retrieving the authentication result. The authentication procedure is described further hereinbelow with reference to FIG. 4.

User area 92 of memory 88 may be configured as a partition of the same non-volatile memory chip as is used for program area 90, or it may alternatively be housed in a separate memory component. User 30 is able to read and write data to and from the user area by means of a suitable utility in soft phone program 94 running on computer 26, and/or possibly using other computer utilities or application programs. Typically, memory 92 comprises a contacts database 100, which is used to store the user's address book. SIM API 98 may include a DLL that permits contacts to be read from the address book in the SIM card memory into database 100 and to be saved from database 100 to the SIM card memory. This feature enables user 30 to transfer contacts between device 22 and the user's mobile phone (not shown) when the user transfers the SIM card.

In addition, user area 92 may contain content 102 (downloaded from content providers 52, for example) and/or messages 104. As noted above, content 102 may comprise audio clips, which the user may play back on device 22 even when the device is disconnected from the computer, as well as content and application programs of other types that may be used on computer 26. Messages 104 may comprise text or multimedia messages, which may then be accessible via the “inbox” and “sent items” messaging features of soft phone program 94. Additionally or alternatively, user area 92 may be configured so as to allow user 30 to use device 22 as a disk-on-key, to save substantially any desired type of data.

FIG. 4 is a message flow diagram that schematically illustrates the process by which soft phone (SP) program 94 authenticates user 30 using SIM card 64 in device 22, in accordance with an embodiment of the present invention. At startup of the soft phone program, computer 26 uses the GetInfo function of SIM API 98 to query the SIM card for the required telephone number information. The soft phone program then sends a SIP registration message, including the user's telephone number (IMSI, and/or possibly other user identification information), to FMC gateway 34. This message also gives the gateway the IP address of computer 26.

Upon receiving the message, gateway 34 queries the home location register (HLR) in network 38, which then queries authorization server 44 for the 128-bit random number (RAND) that is to be used in the challenge of the SIP challenge/response authentication protocol, as provided by GSM standards. Alternatively, the authentication protocol may be based on other types of “SIM” and other standards, such as the User Service Identity Module (USIM) provided by the Universal Mobile Telecommunication System (UMTS). Further alternatively or additionally, the gateway may be configured to generate the random number and complete the authentication protocol autonomously. In either case, the gateway sends an authentication request back to computer 30, such as a SIP 401 (UNAUTHORIZED) message, containing the random number, with the algorithm parameter of the message set to GSM. Upon receiving this message, smart phone program 94 uses the GetAuthInfo function of API 98, as described above, to pass the random number to SIM card 64 and to read the response (RESP) generated by the SIM card using the key that is stored in the SIM card.

Soft phone program 94 passes the response from the SIM card to gateway 34 in a new SIP registration message. The gateway uses this response in authenticating user 30. The gateway then sends a message to the HLR in network 38 to indicate that the user's telephone number is registered, on-line and accessible via the VLR function of the gateway. (The gateway may also retrieve and apply user profile information that is stored under the user's IMSI in the HLR.) Once these steps have been completed, the gateway sends a SIP 200 (OK) message back to computer 30, indicating that the soft phone program can now send and receive telephone calls, as well as other messages.

Optionally, for enhanced security, gateway 34 may require that soft phone program 94 repeat the authentication procedure at certain subsequent times, and particularly when placing telephone calls. For this purpose, for example, when the soft phone program sends a SIP INVITE message to the gateway to initiate a call, the gateway may require the program to carry out an authentication procedure, similar to that described above, before proceeding with the call. If device 22 has been removed from computer 26, or SIM card 64 has been removed from device 22, authentication will fail, and the call will not be made.

When user 30 is done using soft phone program 94, the user may instruct the program to de-register. In this case, the soft phone program sends a de-registration message to gateway 34, which then notifies the HLR that the current registration of the user's telephone number should be erased. The de-registration routine may also use authentication information read from SIM card 64 via API 98. Alternatively or additionally, soft phone program 94 may automatically send a de-registration message to the gateway when device 22 is removed from port 24, before the program terminates, and the gateway may de-register the user automatically after a certain timeout period of inactivity. In any case, when the soft phone program terminates, it is erased from the memory of computer 26 without leaving a trace.

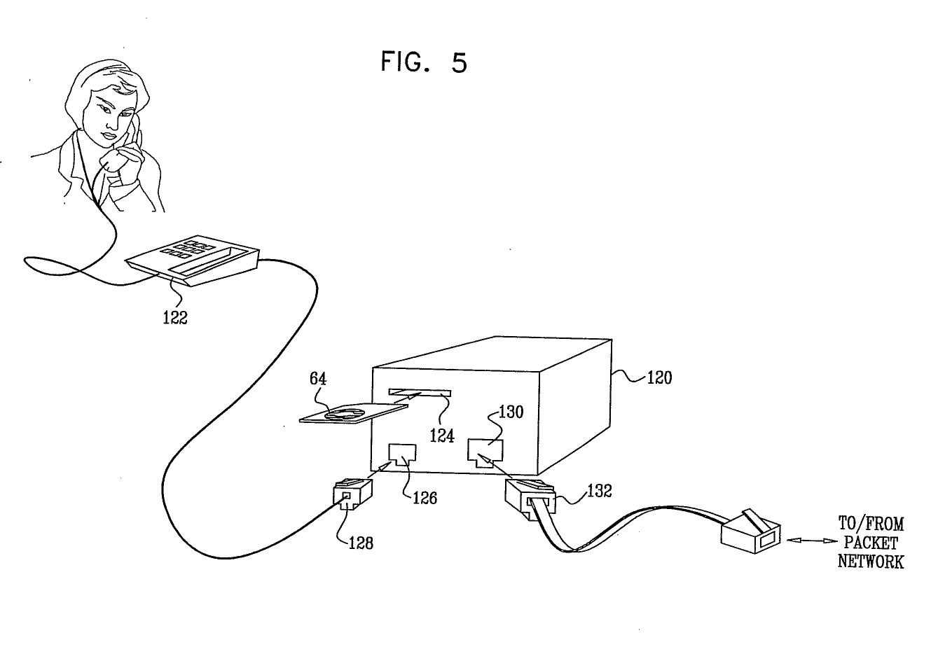

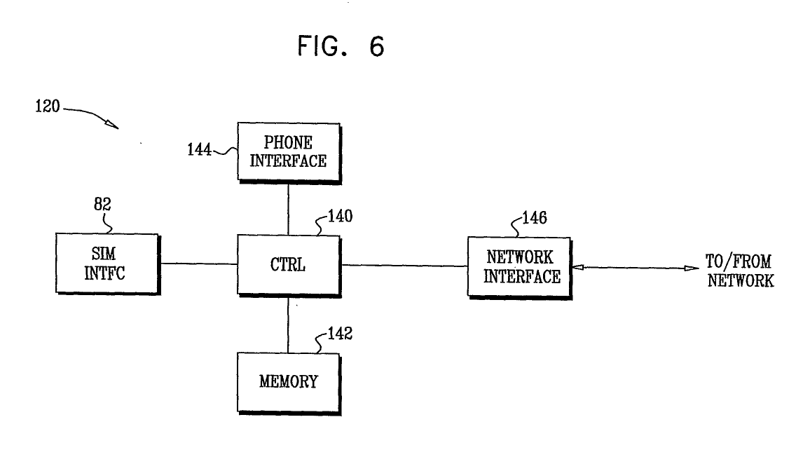

Reference is now made to FIGS. 5 and 6, which schematically illustrate a SIM-based analog telephone adapter device 120, in accordance with another embodiment of the present invention. FIG. 5 shows a pictorial view of the device, while FIG. 6 is a block diagram showing certain functional components of the device. (As in FIG. 3, this view of the functional components is simplified and does not necessarily reflect the actual hardware implementation of device 120.) Device 120 enables a user of an analog telephone 122 to place and receive telephone calls via a packet network, and also to place and receive telephone calls to and from telephone network 38 via FMC gateway 34 using SIM card 64. The operation of the gateway in this regard is similar to that described above.

Device 120 comprises a receptacle 124 for receiving SIM card 64. A controller 140 in device 120 interacts with the SIM card via SIM interface 82, as in device 22. Device 120 also comprises a telephone plug connector 126, for receiving an analog telephone plug 128 of telephone 122, and a packet network connector 130, for receiving a network cable plug 132. For example, plug 128 may be an RJ11 telephone plug, while plug 132 is an RJ45 plug, which connects to an Ethernet local area network (LAN). Alternatively, any other suitable type of plugs and connectors may be used, and the interface between device 120 and network 28 may alternatively be wireless. Telephone 122 is typically a conventional analog telephone, which thus serves, in conjunction with device 120, as a user I/O device for packet telephony.

Controller 140 typically comprises a suitable microprocessor, which runs software stored in a memory 42 in order to perform the functions described herein. The controller communicates with telephone 122 via a phone interface 144, which comprises digital/analog (D/A) and analog/digital (A/D) converters (not shown) for processing voice signals to and from telephone 122, as well as decoding dual-tone multi-frequency (DTMF) signals generated by the telephone keypad. Phone interface 144 typically also comprises a hook detector, ring generator, and other features that are known in the art of analog telephone interfaces.

Controller 140 communicates with the packet network via a network interface 146. When device 120 starts up, a local program in memory 142 causes controller 140 to read user information from SIM card 64 and to use this information in registering with FMC gateway 34. This registration process is similar to that shown above in FIG. 4. At the conclusion of this process, the user of telephone 122 may dial and receive calls via the packet network, using the program running on controller 140 to communicate with gateway 34, as though the telephone was connected directly to telephone network 38. This arrangement enables the operator of network 38 to charge the subscriber for calls and other network services. It also allows the subscriber to use the telephone number associated with SIM card 64 to place and receive calls substantially anywhere in the world.

SIM card 64 that is used in device 120 can also store other information that is useful in device operation, such as configuration data. For example, the SIM card can store IP addresses for use in auto-configuration of connections over the packet network when the device is plugged in.

Although certain aspects of the embodiments of the present invention have been described, for the sake of convenience, using terminology taken from the vocabulary of GSM cellular networks, the principles of the present invention are equally applicable to other types of mobile networks, such as CDMA, TDMA and UMTS networks. It will thus be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. A communication device, comprising:
a computer interface, for coupling to a computer, which is connected to communicate over a packet-switched network;
a secure memory interface, for coupling to a secure memory containing subscriber identification data belonging to a subscriber; and
a program memory, containing an executable application program, which is configured to be read by the computer via the computer interface and upon execution by the computer, causes the computer to communicate via the packet-switched network with a telephony gateway so as to register the subscriber with the gateway using the subscriber identification data and to communicate, under control of a user of the computer, via the gateway with a telephone network.

2. The device according to claim 1, wherein the computer interface comprises a Universal Serial Bus (USB) connector, for coupling to a USB port of the computer.

3. The device according to claim 1, wherein the secure memory comprises a subscriber identification module (SIM) card.

4. The device according to claim 3, wherein the secure memory interface comprises a receptacle for receiving and coupling to the SIM card.

5. The device according to claim 3, wherein the subscriber identification data comprises an international mobile subscriber identity (IMSI), and wherein the SIM card further contains a key for secure authentication of the subscriber.

6. The device according to claim 5, wherein the application program causes the computer to convey to the telephony gateway authentication information responsive to the key, for use by the telephony gateway in authenticating the subscriber with an authentication server belonging to the telephone network.

7. The device according to claim 6, wherein the application program causes the computer to convey the authentication information using a Session Initiation Protocol (SIP) message.

8. The device according to claim 1, wherein the telephone network comprises a cellular telephone network.

9. The device according to claim 1, wherein the executable application program comprises a soft phone program, which causes the computer to place a call to the telephone network.

10. The device according to claim 9, wherein the call comprises a voice telephone call, and comprising an audio interface in the device, for coupling to audio input and output devices, to receive and deliver voice input and output during the voice telephone call.

11. The device according to claim 1, and comprising a data memory, wherein the application program causes the computer to read user data from and write user data to the data memory under the control of the user.

12. The device according to claim 11, wherein the user data comprises contact information that is maintained in an address book of the user.

13. The device according to claim 11, wherein the user data comprises content that is received by the computer via the telephony gateway and is written by the computer to the data memory.

14. The device according to claim 13, wherein the content comprises audio content, and wherein the device comprises an audio interface, for coupling to an audio output device, and a controller, which is configured to play the audio content for output via the audio interface after the device has been disconnected from the computer.

15. The device according to claim 1, wherein the computer interface and the application program are configured so that the application program runs automatically on the computer when the device is coupled to the computer, without installation of the program in a memory of the computer.

16. A communication device, comprising:
a telephone interface, for coupling to an analog telephone;
a network interface, for coupling to a packet-switched network;
a secure memory interface, for coupling to a secure memory containing subscriber identification data belonging to a subscriber; and
a controller, which is configured to communicate via the packet-switched network with a telephony gateway so as to register the subscriber with the gateway using the subscriber identification data and to place a call, under control of a user of the analog telephone, via the gateway to a telephone network.

17. The device according to claim 16, wherein the secure memory comprises a subscriber identification module (SIM) card.

18. The device according to claim 17, wherein the secure memory interface comprises a receptacle for receiving and coupling to the SIM card.

19. The device according to claim 17, wherein the subscriber identification data comprises an international mobile subscriber identity (IMSI), and wherein the SIM card further contains a key for secure authentication of the subscriber.

20. The device according to claim 19, wherein the controller is configured to convey to the telephony gateway authentication information responsive to the key, for use by the telephony gateway in authenticating the subscriber with an authentication server belonging to the telephone network.

21. The device according to claim 16, wherein the telephone network comprises a cellular telephone network.

22. A method for communication, comprising:
coupling a user-authentication device to a computer, the device comprising a secure memory, containing subscriber identification data belonging to a subscriber, and a program memory, containing an executable application program;
executing the application program on the computer;
under control of the soft phone program, establishing communication over a packet-switched network between the computer and a telephony gateway so as to register the subscriber with the gateway using the subscriber identification data; and
after registering the subscriber, initiating the communication, under control of a user of the computer, from the computer via the gateway to a telephone network.

23. The method according to claim 22, wherein coupling the user-authentication device comprises connecting a Universal Serial Bus (USB) connector on the device to a USB port of the computer.

24. The method according to claim 22, wherein the secure memory comprises a subscriber identification module (SIM) card.

25. The method according to claim 24, and comprising plugging the SIM card into a receptacle in the user-authentication device.

26. The method according to claim 24, wherein the subscriber identification data comprises an international mobile subscriber identity (IMSI), and wherein establishing the communication comprises authenticating the subscriber using a key held in the SIM card.

27. The method according to claim 26, wherein authenticating the subscriber comprises conveying to the telephony gateway authentication information responsive to the key, for use by the telephony gateway in authenticating the subscriber with an authentication server belonging to the telephone network.

28. The method according to claim 27, wherein conveying the authentication information comprises sending the authentication information in a Session Initiation Protocol (SIP) message.

29. The method according to claim 22, wherein the telephone network comprises a cellular telephone network.

30. The method according to claim 22, wherein the executable application program comprises a soft phone program, which causes the computer to place a call to the telephone network.

31. The method according to claim 30, wherein the call comprises a voice telephone call, and comprising receiving and delivering voice input and output during the voice telephone call via an audio interface in the user-authentication device.

32. The method according to claim 22, and comprising reading user data from and writing user data to a data memory in the user-authentication device using the application program under the control of the user.

33. The method according to claim 32, wherein the user data comprises contact information that is maintained in an address book of the user.

34. The method according to claim 32, wherein the user data comprises content that is received by the computer via the telephony gateway and is written by the computer to the data memory.

35. The method according to claim 34, and comprising playing the audio content via an audio interface in the user-authentication device after the device has been disconnected from the computer.

36. The method according to claim 22, wherein executing the application program comprises configuring the user-authentication device so that the application program runs automatically on the computer when the device is coupled to the computer, without installation of the program in a memory of the computer.

37. A method for communication, comprising:
coupling an analog telephone adapter to an analog telephone, the adapter comprising a secure memory, containing subscriber identification data belonging to a subscriber;
establishing communication over a packet-switched network between the adapter and a telephony gateway so as to register the subscriber with the gateway using the subscriber identification data; and
after registering the subscriber, placing a call, under control of a user of the analog telephone, from the computer via the gateway to a telephone network.

38. The method according to claim 37, wherein the secure memory comprises a subscriber identification module (SIM) card.

39. The method according to claim 38, and comprising plugging the SIM card into a receptacle in the user-authentication device.

40. The method according to claim 38, wherein the subscriber identification data comprises an international mobile subscriber identity (IMSI), and wherein establishing the communication comprises authenticating the subscriber using a key held in the SIM card.

41. The method according to claim 40, wherein authenticating the subscriber comprises conveying to the telephony gateway authentication information responsive to the key, for use by the telephony gateway in authenticating the subscriber with an authentication server belonging to the telephone network.

42. The method according to claim 37, wherein the telephone network comprises a cellular telephone network.
